(19) United States
(12) Patent Application Publication
(10) Pub. No.: US 2013/0200973 A1
(43) Pub. Date: Aug. 8, 2013

(54) CONDUCTIVE WIRE FOR TRANSFORMER AND MAGNETIC ELEMENT IN SWITCH POWER SUPPLY

(71) Applicant: Jun Sun, Shanghai (CN)

(72) Inventor: Jun Sun, Shanghai (CN)

(73) Assignee: DELTA ELECTRONICS (SHANGHAI) CO., LTD., Shanghai (CN)

(21) Appl. No.: 13/548,593

(22) Filed: Jul. 13, 2012

(30) Foreign Application Priority Data
Feb. 3, 2012 (CN) 201210024465.1

(51) Int. Cl. H01F 27/36; H01F 27/30

(52) U.S. Cl. 336/105; 336/221

(57) ABSTRACT

The present invention relates to a conductive wire for a transformer and a magnetic element in a switch power supply, the magnetic element comprises a transformer and a filter, the transformer comprises a winding base and a coil, the winding base comprises two base bodies and a cylinder locating between the two base bodies, the coil is formed by winding a plurality of the conductive wires in parallel on the cylinder, the conductive wire comprises a conductor and an insulator directly covering an outer periphery of the conductor, a profile of a section of the insulator is a rectangle, a surface contact is formed between the adjacent conductive wires provided in parallel on the cylinder via the profiles of the rectangle sections of the adjacent insulators, and a contact surface forming the surface contact is perpendicular to an axial line of the cylinder.

### CROSS-REFERENCE TO RELATED APPLICATIONS

This non-provisional application claims priority under 35 U.S.C. §119(a) on Patent Application No. 201210024465.1 filed in P.R. China on Feb. 3, 2012, the entire contents of which are hereby incorporated by reference.

### FIELD OF THE PRESENT INVENTION

The present invention relates to a magnetic element in a switch power supply, and more specifically, to a magnetic element and a conductive wire for a transformer in a switch power supply.

### BACKGROUND ART

With the requirements on high frequency and high density for magnetic elements in a switch power supply, the product may become smaller and smaller. A conventional magnetic element comprises a transformer, a filter, and so on. A precondition for making the filer smaller is that the transformer should have good winding consistence. Only if the winding consistence is good, it is convenient to solve EMI (Electro Magnetic Interference) and finally the filter may be made smaller. At present, circular conductive wires, including a variety of insulative circular conductive wires, are used in power supply industry. When the circular conductive wires are used, phenomena, such as interlayer wave pattern, wire-slipping, wire-folding, poor utilization in spatial grooves, and so on, may occur. As shown in FIG. 1A, a wave pattern 1 resulted from the circular conductive wires will make an interlayer uneven, and space may not utilized sufficiently for the circular conductive wires so that spatial grooves 2 are formed. As shown in FIG. 1B, due to existence of the wave pattern 1, under unstable factors in a winding machine or during manual operation, it is easier to yield the phenomenon of wire-slipping, i.e. a conductive wire which should be in a position A slides to a position B, thereby making the winding uneven. In order to utilize the spatial grooves 2 sufficiently, the spatial grooves 2 may be filled in a manner that thick conductive wires and thin conductive wires are wound in parallel together, but a phenomenon of interlayer unevenness still occur (as shown in FIG. 1C). As the number of layer in the winding is more, these phenomena become more obvious, thereby making interlayer more uneven, making winding process more difficult and poor, and finally making the processing consistence of the product poor. When the processing consistence is poor, it is more difficult to solve EMI, i.e. it is quite difficult to perform compensation in a body of the transformer, and thus it is required to perform filtering in the filter. Moreover, when the processing consistence is poor, a volume of the filter may be increased, which is not conformity with a requirement on a small volume of the magnetic element.

In order to overcome the above phenomena, it is necessary to modify a design of the circular conductive wire of the conventional transformer.

### SUMMARY OF THE PRESENT INVENTION

In view of the problems of interlayer unevenness of a coil, uneasy winding, poor processing consistence due to using circular conductive wires in the conventional transformer, a technical problem to be solved by the present invention is to provide a conductive wire for a transformer so as to promote the processing consistence of the transformer and thus to more efficiently solve EMI.

In order to solve the above problem, the present invention provides a conductive wire for a transformer, the transformer comprises a winding base and a coil, the winding base comprises two base bodies and a cylinder locating between the two base bodies, the coil is formed by winding a plurality of the conductive wires in parallel on the cylinder, the conductive wire comprises a conductor and an insulator directly covering an outer periphery of the conductor, a profile of a section of the insulator is a rectangle, a surface contact is formed between the adjacent conductive wires provided in parallel on the cylinder via the profiles of the rectangle sections of the adjacent insulators, and a contact surface forming the surface contact is perpendicular to an axial line of the cylinder.

Moreover, in order to reduce a need of a magnetic element in a switch power supply on the compensation function of a filter and conveniently further make the magnetic element smaller, the present invention provides a magnetic element in a switch power supply comprising a transformer and a filter, the transformer comprises a winding base and a coil, the winding base comprises two base bodies and a cylinder locating between the two base bodies, the coil is formed by winding a plurality of the conductive wires in parallel on the cylinder, the conductive wire comprises a conductor and an insulator directly covering an outer periphery of the conductor, a profile of a section of the insulator is a rectangle, a surface contact is formed between the adjacent conductive wires provided in parallel on the cylinder via the profiles of the rectangle sections of the adjacent insulators, and a contact surface forming the surface contact is perpendicular to an axial line of the cylinder.

The beneficial effects of the present invention are as follows: since a profile of a section of the insulator is a rectangle, when the coil of the transformer is wound, a surface contact is formed between every two adjacent rows of the conductive wires via the profiles of the rectangle sections of the adjacent insulators, and a contact surface between the every two adjacent rows of the conductive wires is perpendicular to an axial line of the cylinder, thus not only the conductive wire of each row in the coil may have a same height, but also it may be convenient to adjust a width of the conductive wire, the space may be utilized sufficiently, it may avoid the wave pattern and space grooves from occurring and may avoid phenomenon of wire-slipping from occurring, and the coil may have better consistency and better resistance to EMI, thereby compensation from the filter may be reduced, so as to conveniently make the magnetic element smaller.

Hereinafter, the present invention will be described in details in conjunction with the drawings and the preferred embodiments which are not intended to limit the present invention.

### BRIEF DESCRIPTION OF THE DRAWINGS

FIGS. 1A-1C are schematic views illustrating winding of circular conductive wires in background art;

FIG. 2 is a schematic view illustrating winding of rectangular conductive wires according to an embodiment of the present invention;

FIG. 3 is a schematic view illustrating a section of a rectangular conductive wire according to an embodiment of the present invention;

FIG. 4 is a schematic view illustrating a section of a rectangular conductive wire according to another embodiment of the present invention;

FIG. 5 is a schematic view illustrating a section of a rectangular conductive wire according to still another embodiment of the present invention;

FIG. 6 is a schematic view illustrating a section of a rectangular conductive wire according to further another embodiment of the present invention;

FIG. 7 is a local schematic view illustrating a transformer according to an embodiment of the present invention;

FIG. 8 is a schematic view illustrating winding of rectangular conductive wires according to another embodiment of the present invention;

FIG. 9 is an EMI plot of a coil of a transformer formed by winding circular conductive wires in background art; and

FIG. 10 is an EMI plot of a coil of a transformer formed by winding rectangular conductive wires according to the present invention.

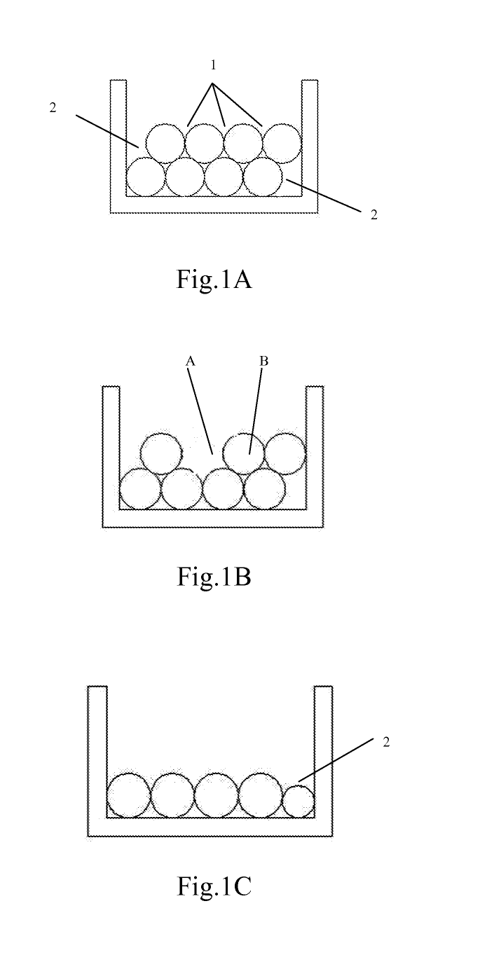

The referential numerals for elements are described as follows.
1 wave pattern
2 spatial groove
3 rectangular conductive wire
31, 31′ contact surface
32 insulator
10 winding base
11, 12 base body
13 cylinder
20 coil

### DESCRIPTION OF THE PREFERRED EMBODIMENTS

Hereinafter, technical solutions of the present invention will be described in details in conjunction with the drawings and the preferred embodiments, so as to further understand objects, solutions, and effects of the present invention but not to limit protection scopes of appended claims of the present invention.

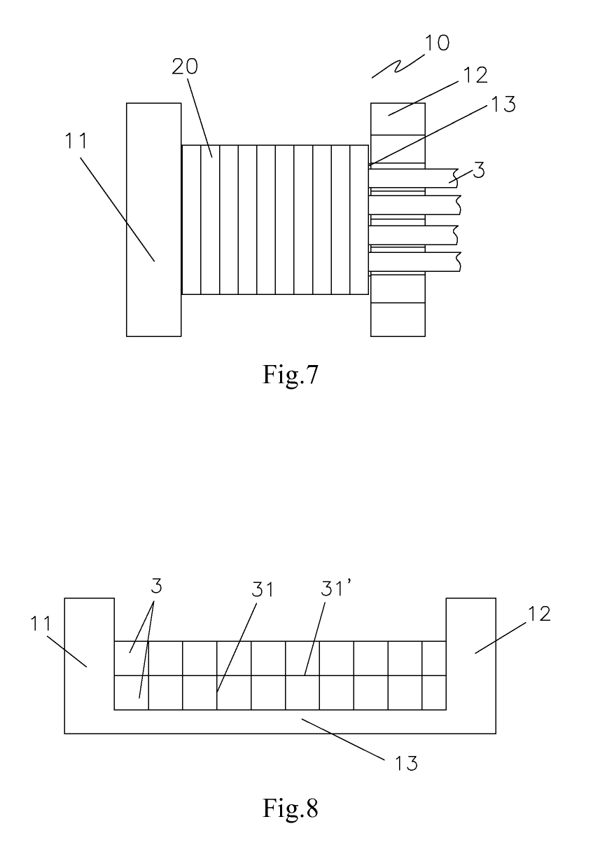

A magnetic element in a switch power supply provided by the present invention is applicable to any types of power supplies (such as a DC power supply station, a power charge station, a new energy, and so on) and any places (such as an official power supply, a communication power supply, an outdoor power supply, an indoor power supply, and so on). The type of the magnetic element of in the power supply mainly comprises a transformer and a filter. As shown in FIG. 7, the transformer comprises a winding base 10 and a coil 20 provided on the winding base 10. The winding base 10 comprises two base bodies 11, 12 and a cylinder 13 locating between the two base bodies 11, 12. The coil 20 is formed by winding a plurality of conductive wires 3 in parallel on the cylinder 13. Since the present invention mainly focuses on the conductive wire 3, the other structures relating to the transformer are not described herein. A filter is used to compensate EMI of the transformer. Hereinafter, the conductive wire of the present invention will be only described in details.

As shown in FIGS. 3-6, the conductive wire 3 comprises a conductor (not shown) and an insulator 32 covering an outer periphery of the conductor, and a profile of a section of the insulator 32 is a rectangle (it should be noted that the section herein refers not to a longitudinal section or an oblique section but a cross section). Specifically, the profile of the section of the insulator 32 may be square (as shown in FIG. 3 and FIG. 4), moreover, a part of the insulator 32 covering the conductor may be formed as a circular opening or a square opening. The profile of the section of the insulator 32 may be also a square-like shape with chamfers (as shown in FIG. 5), and in addition, the part of the insulator 32 covering the conductor may be formed as a circular opening. Although only the circular opening is illustrated in the embodiment of FIG. 5, in practical invention, the part of the insulator 32 covering the conductor may be formed as a square opening. The profile of the section of the insulator 32 may be rectangular (as shown in FIG. 6), and moreover, the part of the insulator 32 covering the conductor may be formed as a square opening. Although only the square opening is illustrated the embodiment of in FIG. 6, in practical invention, the part of the insulator 32 covering the conductor may be formed as a circular opening.

It should be noted that the square opening or the rectangular opening described above may be referred to as a rectangle opening as a whole.

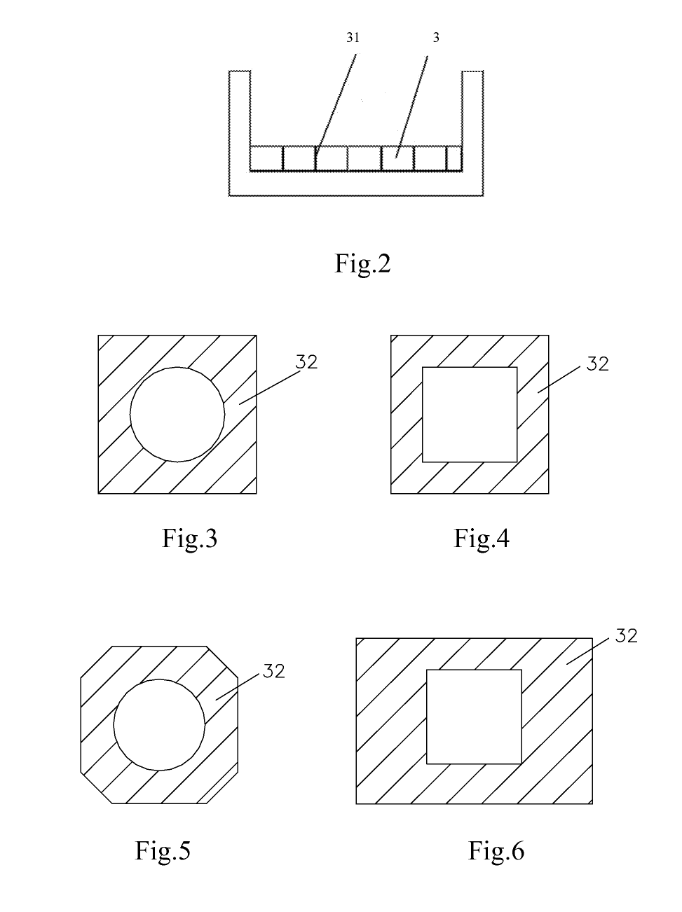

Further referring to FIG. 2 and FIG. 7, when a coil of the transformer is wound with rectangle conductive wires of the present invention, a surface contact is formed between the adjacent conductive wires provided in parallel on the cylinder 13 via the profiles of the rectangle sections of the adjacent insulators 32, and a contact surface 31 between every two adjacent rows of the conductive wires is perpendicular to an axial line of the cylinder 13. The coil formed as such is even in an interlayer, does not have a wave pattern, and can assure a height uniform. Moreover, by adjusting a width of the conductive wire, the space may be sufficiently used, thereby avoiding yielding spatial grooves, i.e. making the conductive wires 3 distributing on the whole cylinder 13 along an axial direction of the cylinder 13.

FIG. 2 and FIG. 7 only illustrate a case that the coil has a single layer. As shown in FIG. 8, taking two layers of coils as an example, a surface contact is formed between the corresponding conductive wires 3 along a corresponding row in the two layers of the coils via the profiles of the corresponding rectangle sections of the insulators 3, and a contact surface 31′ formed between the corresponding conductive wires 3 along the corresponding row in the two layers of the coils is in parallel with the axial line of the cylinder 13.

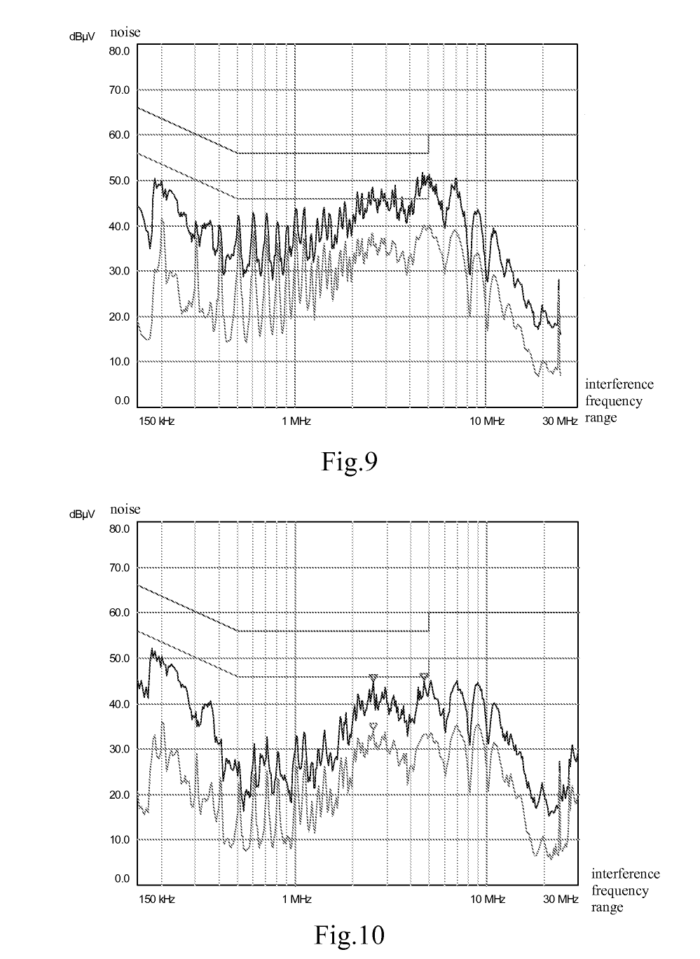

In combination with referring to FIG. 9 and FIG. 10, as can be seen from the comparison between the two figures, when a coil is formed by winding circular conductive wires, interference waveform of the coil might be beyond the critical line, that is to say, EMI property of the coil is worse; when a coil is formed by winding rectangle conductive wires, interference waveform of the coil is not beyond the critical line, that is to say, EMI property of the coil is better.

As can be seen from the above, the present invention may have following advantages with use of rectangle conductive wires.

(1) Interlayer wave pattern may be solved, phenomena, such as wire-slipping, wire-folding, and so on, do not occur, processing consistence is good.

(2) Product efficiency may be promoted.

(3) Rectangle conductive wire not only can assure a uniform height but also may be adjusted in width, so that space utilization may be higher.

(4) Winding consistence is better, it is more convenient to solve EMI, and is convenient to make the volume of the magnetic element smaller.

Certainly, the present invention may have many other embodiments. It is obvious for the person skill in the art to make various modifications and variations without departing from the spirit and scope of the present invention, these modification and changes should be fallen within the scope of the appending clams and equivalents thereof of the present invention.

What is claimed is:

1. A conductive wire for a transformer, the transformer comprising a winding base and a coil, the winding base including two base bodies and a cylinder locating between the two base bodies, the coil being formed by winding a plurality of the conductive wires in parallel on the cylinder, the conductive wire having a conductor and an insulator directly covering an outer periphery of the conductor, wherein a profile of a section of the insulator is a rectangle, a surface contact is formed between the adjacent conductive wires provided in parallel on the cylinder via the profiles of the rectangle sections of the adjacent insulators, and a contact surface forming the surface contact is perpendicular to an axial line of the cylinder.

2. The conductive wire for the transformer according to claim 1, wherein the conductive wires are distributed on the whole cylinder along an axial direction of the cylinder.

3. The conductive wire for the transformer according to claim 1, wherein the coils has a plurality of layers, a surface contact is formed between the corresponding conductive wires along a corresponding row in the every two adjacent layers of the coils via the profiles of the corresponding rectangle sections of the insulators, and a contact surface between the corresponding conductive wires along the corresponding row in the every two adjacent layers of the coils is in parallel with the axial line of the cylinder.

4. The conductive wire for the transformer according to claim 1, wherein the profile of the section of the insulator is square or rectangular.

5. The conductive wire for the transformer according to claim 1, wherein the profile of the section of the insulator a rectangle-like shape with chamfers.

6. The conductive wire for the transformer according to claim 1, wherein a part of the insulator covering the conductor is be formed as a circular opening or a rectangle opening.

7. A magnetic element in a switch power supply, comprising a transformer and a filter, the transformer comprising a winding base and a coil, the winding base including two base bodies and a cylinder locating between the two base bodies, the coil being formed by winding a plurality of the conductive wires in parallel on the cylinder, the conductive wire having a conductor and an insulator directly covering an outer periphery of the conductor, wherein a profile of a section of the insulator is a rectangle, a surface contact is formed between the adjacent conductive wires provided in parallel on the cylinder via the profiles of the rectangle sections of the adjacent insulators, and a contact surface forming the surface contact is perpendicular to an axial line of the cylinder.

8. The magnetic element in the switch power supply according to claim 7, wherein the conductive wires are distributed on the whole cylinder along an axial direction of the cylinder.

9. The magnetic element in the switch power supply according to claim 7, wherein the coils has a plurality of layers, a surface contact is formed between the corresponding conductive wires along a corresponding row in the every two adjacent layers of the coils via the profiles of the corresponding rectangle sections of the insulators, and a contact surface between the corresponding conductive wires along the corresponding row in the every two adjacent layers of the coils is in parallel with the axial line of the cylinder.

10. The magnetic element in the switch power supply according to claim 7, wherein the profile of the section of the insulator is square or rectangular.

11. The magnetic element in the switch power supply according to claim 7, wherein the profile of the section of the insulator a rectangle-like shape with chamfers.

12. The magnetic element in the switch power supply according to claim 7, wherein a part of the insulator covering the conductor is be formed as a circular opening or a rectangle opening.
